(19) United States
(12) Patent Application Publication
(10) Pub. No.: US 2017/0124543 A1
(43) Pub. Date: May 4, 2017

(54) POINT TRANSACTION SYSTEM AND METHOD FOR MOBILE COMMUNICATION DEVICE

(71) Applicant: ABANCAST LIMITED, Tortola (BV)

(72) Inventor: Pen-Lo Wang, New Taipei City (TW)

(21) Appl. No.: 15/408,431

(22) Filed: Jan. 18, 2017

Related U.S. Application Data
(62) Division of application No. 14/048,051, filed on Oct. 8, 2013.

(51) Int. Cl. G06Q 20/10; G06Q 20/20; G06Q 20/32; G06Q 20/38

(52) U.S. Cl. CPC G06Q 20/102; G06Q 20/382; G06Q 20/20; G06Q 20/3227; G06Q 2220/00

(57) ABSTRACT

A point transaction system and method for mobile communication device is provided. The system includes at least an encryption chip, a plurality of function menu defined in the encryption chip, a plurality of storage devices and at least a point unit, where the encryption chip is integrated with the SIM card in an electronic communication device, the storage devices are connected respectively to the electronic communication device, and the point unit is connected to the plurality of storage devices. The method includes: a first user changes the currency to point unit at a corresponding venue and stores to an account of the user; the first user transmits the point unit stored inside the account to an account of a second user by operating a first electronic communication device; and the second user uses the point unit in the account of the second user through using a second electronic communication device.

### CROSS-REFERENCE TO RELATED APPLICATION

This is a division of the co-pending patent application Ser. No. 14/048,051, filed Oct. 8, 2013.

### TECHNICAL FIELD OF THE INVENTION

The present invention generally relates to a point transaction system and method for mobile communication device, and more specifically to a point transaction system and method for mobile communication device suitable for point transmission and with high security.

### DESCRIPTION OF THE PRIOR ART

In the modern commercial world, many transactions are conducted with a large amount of capital. For transferring the capital, the participating parties often are required to go to the corresponding financial venue for fund transfer, such as, a bank or an ATM (Automatic Teller Machine)

Many issues, such as the exchange rate, whether there are business dealings between transacting banks and so forth, arise as the financial transaction moves from domestic to international. Both the transferring side and the receiving side often must deploy specific personnel with skills to handle the process.

In addition, employees working overseas often use mobile phones to communicate with family. For overseas employees, the aforementioned financial activity sometimes poses more complexity as the overseas employees often cannot obtain local identification documents in a timely manner.

As more functions are added to mobile phones, a corresponding add-on attached to the mobile phone to access more services is developed. However, no means is available to address the aforementioned financial problem.

Furthermore, some network platforms are provided to address some of the above mentioned problems. By allowing the user to log in to the platform, the platform transforms cash into the transaction point of the platform so as to replace cash transaction with point transaction. Nevertheless, this type of platform is only operable on computers and the security relies on the user account and password mechanism. When the account/password is stolen, the points can be easily transferred away to cause loss to the user.

Hence, it is imperative to devise a system and method to address the aforementioned issues more conveniently.

### SUMMARY OF THE INVENTION

The present invention has been made to overcome the aforementioned drawback of conventional systems by providing a point transaction system and method for mobile communication device for point transmission with high security.

The primary object of the present invention is: to integrate an encryption chip to a mobile phone, and through the operation of the encryption chip, to transmit the point unit in a corresponding storage device to another storage device for subsequent operations. Through the above technology, the problems of the conventional system are solved to achieve the object of point transmission in a secured manner.

To achieve the above object, a point transaction system for mobile communication device includes at least an encryption chip, a function menu defined in the encryption chip, a plurality of storage devices, and at least a point unit, where the encryption chip is integrated with the SIM card in an electronic communication device, the storage devices are connected respectively to the electronic communication device, and the point unit is connected to the plurality of storage devices.

The method includes the following steps:

(a) a first user changes the currency to point unit at a corresponding venue and stores to an account of the user;

(b) the first user transmits the point unit stored inside the account to an account of a second user by operating a first electronic communication device; and

(c) the second user uses the point unit in the account of the second user through using a second electronic communication device.

With the above system and method, when a transmitting side intends to transmit, the transmitting side can operate the electronic communication device integrated with encryption chip and the function menu to transmit the point unit stored inside the storage device of the electronic communication device, and then the receiving side can use the point unit subsequently. As such, the transaction parties can use electronic communication device to accomplish the transaction transmission without visiting financial venues, such as, banks. The system and the method can be used anytime and anywhere to achieve point transmission in a secured manner.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a schematic view of a preferred embodiment of the system according to the present invention.

FIG. 2 shows a flowchart of a preferred embodiment of the method according to the present invention.

FIG. 3 shows a first schematic view of the operation of a preferred embodiment according to the present invention.

FIG. 4 shows a second schematic view of the operation of a preferred embodiment according to the present invention.

FIG. 5 shows a third schematic view of the operation of a preferred embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

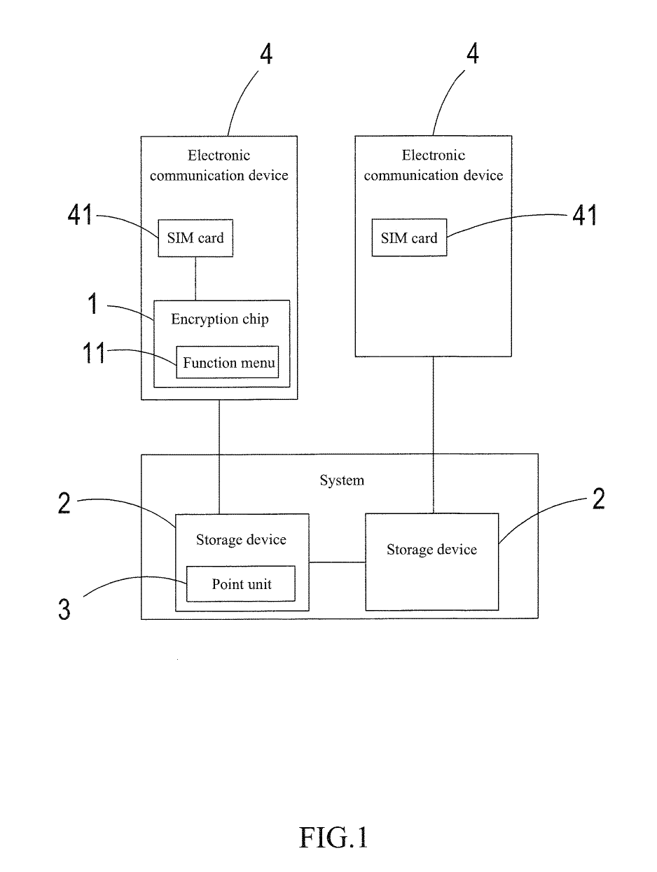

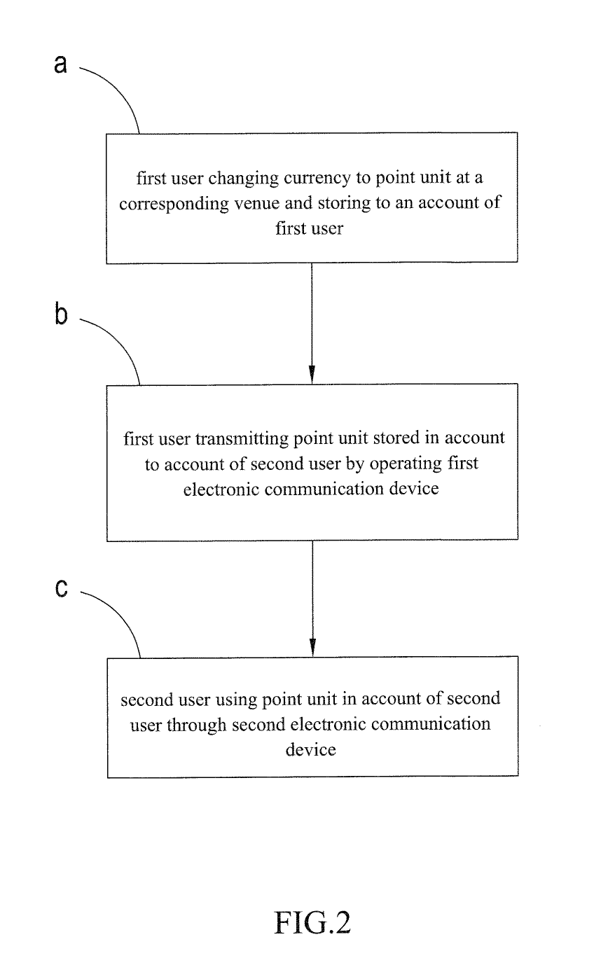

FIGS. 1 and 2 respectively show a schematic view and a flowchart of a preferred embodiment of the system and method according to the present invention. As shown in the drawings, the system of the present invention includes:

at least an encryption chip 1, the encryption chip 1 being integrated with a SIM card 41 inside of a electronic communication device 4;

a function menu 11, defined by the encryption chip 1 for a user to operate on;

a plurality of storage devices 2, connected respectively to the electronic communication device; and

at least a point unit 3, connected to the plurality of storage devices 2.

The electronic communication device is a mobile communication device, which can be further defined as one of a mobile phone, a tablet computer, or a notebook computer.

The steps of operation includes:

(a) A first user changes the currency to point unit at a corresponding venue and stores to an account of the user;

(b) The first user transmits the point unit stored inside the account to an account of a second user by operating a first electronic communication device; and

(c) The second user uses the point unit in the account of the second user through using a second electronic communication device.

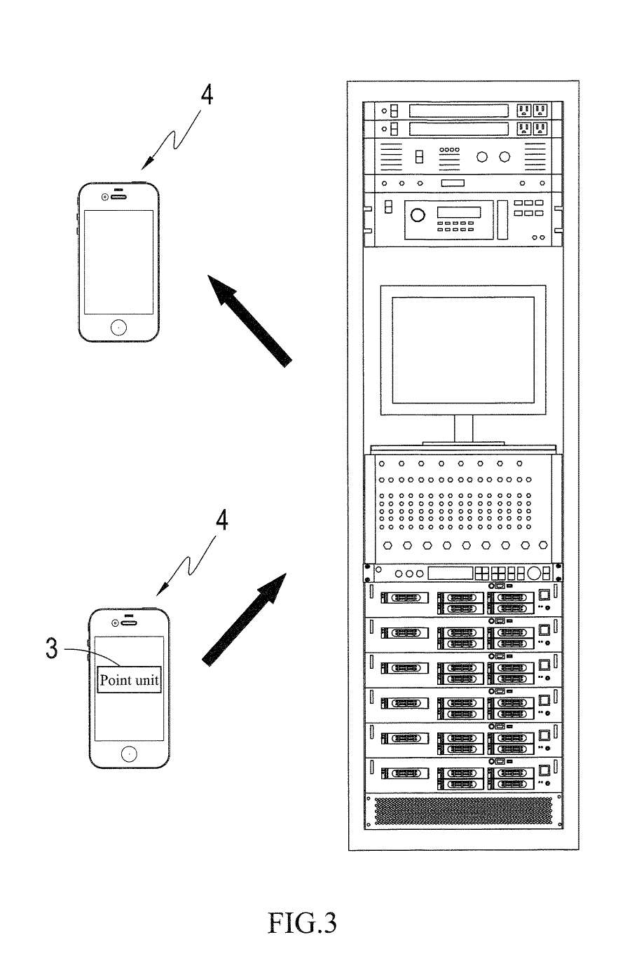

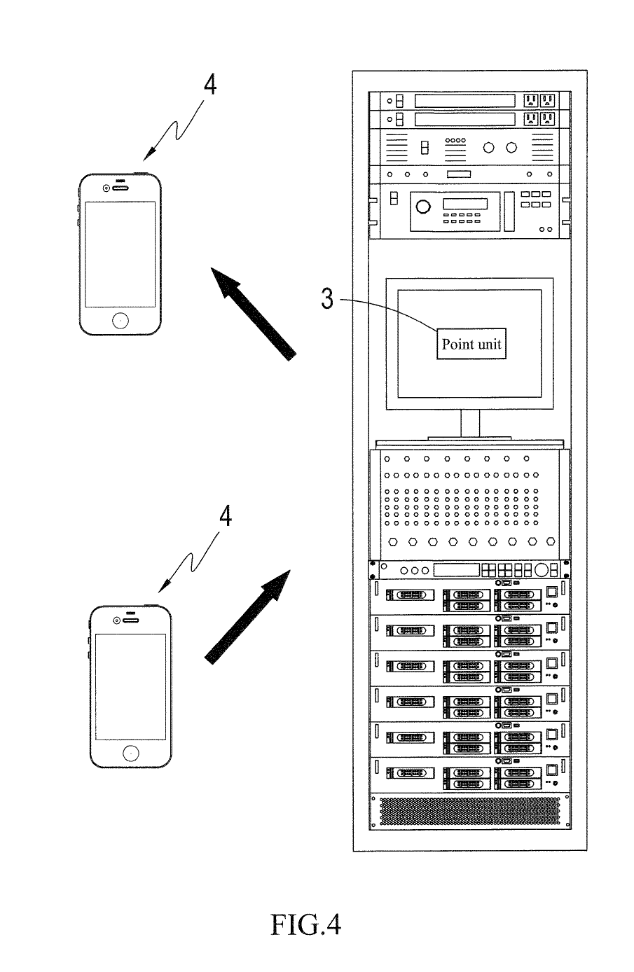

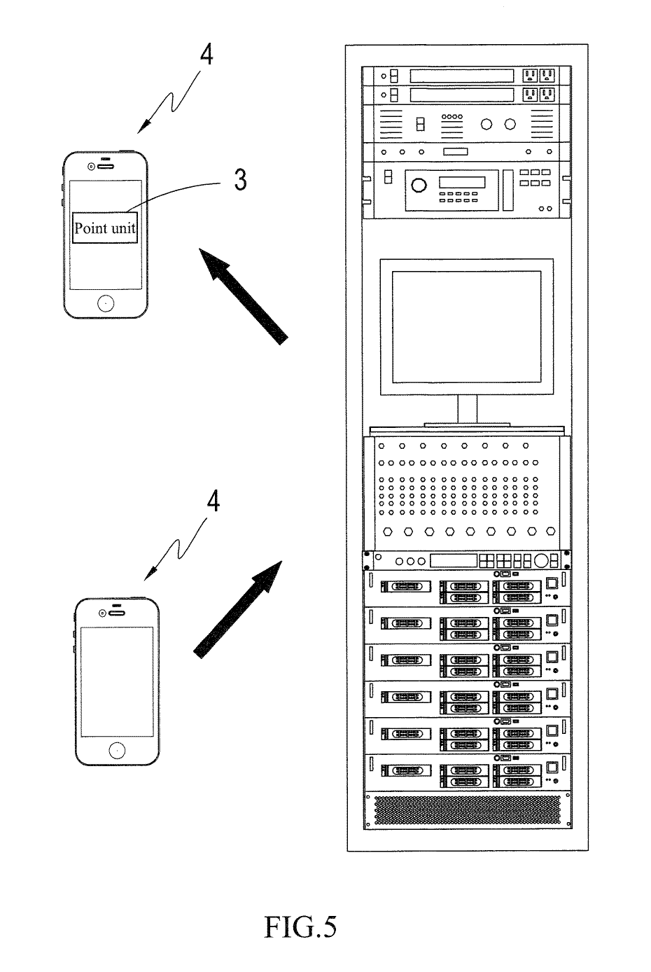

Referring to FIGS. 1, 3, 4, and 5, which respectively show a schematic view of the system and first to third schematic views of the operation of a preferred embodiment according to the present invention, the drawings clearly show that when the system is first used, the transmitting side must integrate the encryption chip 1 to the electronic communication device 4. By attaching the encryption chip 1 to the SIM card 41 to make the operation linked and forming a corresponding storage device 2 at the system, the currency can be transformed into point unit 3 and stored inside the storage device 2 through subsequent operations by the related unit and the user. To transmit the point unit 3, the user operates the electronic communication device 4, in combination with the operation of encryption chip 1, a randomly generated encryption code is transmitted to the electronic communication device 4 at the receiving side, and the user at the receiving side is informed by a message that a point unit 3 is transmitted. The user at the receiving side, if a first time user, applies to the system to form a corresponding storage device 2 and inputs the encryption code to store the received point unit 3 to the storage device 2 at the receiving side to accomplish transmission. If the receiving side already has a storage device 2, no application to the system is required, and the user can input the encryption code directly to receive the point unit 3. With the above structure and operation, the transmission can be conducted entirely on electronic communication device 4 anytime and anywhere. The system can further collaborate with finance institutes to simplify the currency exchange and process. For example, a transmitting side (i.e., the first user) can exchange the local currency of Country A to point unit 3 and stored into the account of the first user (i.e., corresponding storage device 2). Through operating the first electronic communication device, the first user transfers the point unit stored in the account to an account of a second user (i.e., the storage device 2 corresponding to the second user). The second user, residing in a Country B, can use the point unit 3 after receiving from the first user, such as, for payment or for exchanging into local currency of Country B. As such, the system provides a means suitable for point transmission in a secured manner.

Hence, the feature of the point transaction system and method for mobile communication device of the present invention provides the following advantage: by simply integrating SIM card 41 on electronic communication device 4 with encryption chip 1, the present invention transmits a point unit 3 to eliminate the currency exchange problems thus providing a means suitable for point transmission in a secured manner.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A point transaction method for mobile communication device, comprising the following steps:
a first user changing a currency to point unit at a corresponding venue and storing to an account of the user;
the first user transmitting the point unit stored inside the account to an account of a second user by operating a first electronic communication device; and
the second user using the point unit in the account of the second user through using a second electronic communication device.

2. The point transaction method for mobile communication device according to claim 4, wherein the first electronic communication device integrates an encryption chip, the encryption chip being integrated to a SIM card in the electronic communication device, the encryption chip defining a function menu for a user to operate on.

3. The point transaction method for mobile communication device according to claim 4, wherein the currency is a currency of a country and the corresponding venue is a service location disposed in the country,

4. The point transaction method for mobile communication device according to claim 4, wherein the point unit is used for payment or exchanging into a local currency of the country.
